(19) United States
(12) Patent Application Publication
(10) Pub. No.: US 2026/0269875 A1
(43) Pub. Date: Sep. 10, 2026

(54) CHANNEL STATE INFORMATION REPORTING FOR THE FORWARD-LINK OF RECONFIGURABLE INTELLIGENT SURFACES

(71) Applicant: Lenovo (Singapore) Pte. Ltd., Singapore (SG)

(72) Inventors: Ali Ramadan ALI, Kraiburg am Inn (DE); Karthikeyan GANESAN, Nauheim (DE); Kahled Nafez Rauf ARDAH, Ilmenau (DE)

(73) Assignee: Lenovo (Singapore) Pte. Ltd., Singapore (SG)

(21) Appl. No.: 19/163,251

(22) PCT Filed: Mar. 7, 2024
(86) PCT No.: PCT/IB2024/052211

§ 371 Date: Sep. 8, 2025

Related U.S. Application Data
(60) Provisional application No. 63/488,909, filed on Mar. 7, 2023.

(51) Int. Cl. H04B 7/04; H04B 7/06

(52) U.S. Cl. CPC H04B 7/04013; H04B 7/0626

(57) ABSTRACT

Devices and methods are presented for wireless communication at a reconfigurable intelligent surface. The method includes receiving, from a network device, a first configuration message having separate channel state information reference signals for separately measuring a channel of (i) a backhaul link between the reconfigurable intelligent surface and the network device and (ii) an access link between the user equipment and the reconfigurable intelligent device. The method includes receiving a second configuration message having an indication of resources that a controller should utilize to report the channel state information (CSI) on an uplink channel between the reconfigurable intelligent surface and the network device, the resources utilized to send CSI for the backhaul link and for the access link. The method includes reporting separate CSI of the backhaul link and of the access link on an uplink of a C-link communicatively connecting the reconfigurable intelligent surface with the network device.

### PRIORITY APPLICATION

This application claims priority to U.S. provisional application No. 63/488,909, filed Mar. 7, 2023, the content of which is fully incorporated herein by reference.

### TECHNICAL FIELD

The present disclosure relates in general to wireless network communications, and more particularly to wireless network communications involving reconfigurable intelligent surfaces.

### BACKGROUND

A wireless communications system may include one or multiple network communication devices, including base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, and other suitable radio access technologies beyond 5G (e.g., sixth generation (6G)).

One recent development in wireless communication involves reconfigurable intelligent surfaces, which are utilized as intermediary devices to reflect wireless communication signals between a network node or base station and a user equipment, among other uses. Challenges exists with the use of these intermediary devices to reflect the communicated signals particularly since the channel state information received from the user equipment includes the combined effects of the cascaded (received and reflected) channels and thus cannot be utilized by the base station to configure optimal states for downlink and uplink signal transmissions to and from the user equipment.

### SUMMARY

The present disclosure relates to devices and methods for configuring a reconfigurable intelligent surface (RIS) to provide separate reports of channel state information for the forward link with a communication device, such as a user equipment, from CSI reports of the downlink to the RIS in order to enable a network device, such as a gNB, to provide optimal configuration of the RIS to reflect downlink and uplink signals to and from the communication device.

According to a first aspect, some implementations of the method and apparatuses described herein may include a method for wireless communication at a network device, such as a gNB. In one or more embodiments, the method may include transmitting, by a controller of the network device to a second controller of a reconfigurable intelligent surface, a first configuration message that includes separate channel state information reference signals for separately measuring a channel of (i) a backhaul link between the reconfigurable intelligent surface and the network device and for (ii) an access link between the user equipment and the reconfigurable intelligent device. In one or more embodiments, the method may also include transmitting, by the controller, a second configuration message comprising an indication of resources that the second controller should utilize to report the channel state information on an uplink channel between the reconfigurable intelligent surface and the network device. The resources are utilized to send both channel state information for the backhaul link and for the access link.

In one or more embodiments, the method may include transmitting, to the user equipment (UE), a configuration for an access link reference signal transmitted by the RIS. The method may include receiving from the UE, on a Uu connecting the UE and the network device via the RIS, a channel state information (CSI) report of the access link between the RIS and the UE.

According to a second aspect, some implementations of the method and apparatuses described herein may include a method for wireless communication at an intermediary network device providing a reconfigurable intelligent surface. In one or more embodiments, the method may include receiving, from a network device via at least one communication link established through a network, a first configuration message that includes separate channel state information reference signals for separately measuring a channel of (i) a backhaul link between the reconfigurable intelligent surface and the network device and for (ii) an access link between the user equipment and the reconfigurable intelligent device. The method may include receiving, from the network device, a second configuration message comprising an indication of resources that the second controller should utilize to report the channel state information on an uplink channel between the reconfigurable intelligent surface and the network device. The resources are utilized to send both channel state information for the backhaul link and for the access link. The method may include reporting separate CSI of the backhaul link and of the access link on an uplink of a C-link communicatively connecting the reconfigurable intelligent surface with the network device.

In one or more embodiments, the method may include transmitting to the user equipment (UE), a configuration for measuring the access link and reporting an access link reference signal. The method may include receiving, from the UE, a channel state information (CSI) report of the access link between the device and the UE. The method may include forwarding the received CSI report to the network device as an access link CSI report.

According to a third aspect, some implementations of the method and apparatuses described herein may include a method for wireless communication at a communication device, such as a UE. In one or more embodiments, the method may include receiving, by a controller of the communication device, a configuration message originating from a network device, the configuration message including information for configuring an access link reference signal. The method may include in response to receiving the configuration message, configuring the device to measure an access link between the device and the reconfigurable intelligent surface and provide a CSI report of the access link. The method may include transmitting, to the network device, the CSI report of the access link.

In one or more embodiments, the method may include receiving, from the reconfigurable intelligent surface, a request to establish a device-to-device connection, the request comprising reference signals to be exchanged during device-to-device communication. The method may include establishing the device-to-device connection via the wireless communication interface. The method may include forwarding, to the reconfigurable intelligent surface, a CSI RS for transmitting to the network device via a Uu link over the C-link.

In one or more embodiments, the method may include receiving, from the network device, a resource configuration to report, on a Uu link, a measured access channel between the reconfigurable intelligent surface and the device. The method may include, in response to receiving the resource configuration: measuring one or more characteristics of the access channel; generating a measured access channel report; and transmitting the measured access channel report on the Uu link to the network device, via the reconfigurable intelligent surface.

### BRIEF DESCRIPTION OF THE DRAWINGS

FIG. 1 illustrates an example of a wireless communications system enabling wireless communication and which supports configuring a reconfigurable intelligent surface with optimal parameters to reflect downlink and uplink signals to and from a communication device, in accordance with aspects of the present disclosure.

FIG. 2A presents a diagram of an example communication system showing CSI-RS transmission to a user equipment (UE) via RIS elements that reflect each received CSI-RS beam as multiple beams towards the UE, according to the prior art.

FIG. 2B illustrates an example collective of CSI-RS time domain resources required for a single gNB beam towards the RIS as presented within the communication system of FIG. 2A, according to prior art.

FIG. 3 illustrates example components of a RIS, including the RIS controller and active RIS elements that are configurable, based on configuration messages provided by/from a gNB controller, to enable the RIS to provide optimal uplink and downlink signal communication with a communication device, in accordance with aspects of the present disclosure.

FIG. 4 illustrates example CSI reporting for the access link using device-to-device sidelink communication between the RIS and the UE, in accordance with aspects of the present disclosure.

FIG. 5 illustrates an example of a block diagram 500 of a network device 502 that supports wireless communication and configuring of an RIS, in accordance with aspects of the present disclosure.

FIG. 6 illustrates an example of a block diagram 600 of an intermediate network device 602 that provides an RIS to support wireless communication with a communication device, in accordance with aspects of the present disclosure.

FIG. 7 illustrates an example of a block diagram 700 of a communication device 702 that supports wireless communication and SL communication with a reconfigurable intelligent surface for access channel state reporting, in accordance with aspects of the present disclosure.

FIG. 8 illustrates a flowchart of a method, performed by a network device, for configuring a reconfigurable intelligent surface with optimal parameters to reflect downlink and uplink signals to and from a communication device, in accordance with aspects of the present disclosure.

FIG. 9 illustrates a flowchart of a method, performed by an intermediate network device, for receiving configuration messages that enables transmission of separate CSI reports for an access channel and a C-link, in accordance with aspects of the present disclosure.

FIG. 10 illustrates a flowchart of a method, performed by a communication device, for supporting wireless communication and providing CSI reports of an access channel between the RIS and the device, separate from CSI reports of a downlink channel to the RIS to enable optimal configuration of the RIS, in accordance with aspects of the present disclosure.

### DETAILED DESCRIPTION

Aspects of the present disclosure provide methods and devices for configuring a reconfigurable intelligent surface (RIS) to provide separate reports of channel state information for the forward and the access links with a communication device, such as a user equipment, from CSI reports of the downlink to the RIS in order to enable a network device, such as a gNB, to provide optimal configuration of the RIS to reflect downlink and uplink signals to and from the communication device. Additional aspects of the disclosure provide for the related processes of the RIS controller and the configuration of the controller of the communication device or user equipment to provide the separate CIS reports.

In the New Radio (NR) protocol two types of CSIs are defined, Zero-power (ZP) CSI-RS and non-zero-power (NZP) CSI-RS. For a zero-power CSI-RS configured by the ZP-CSI-RS-Resource IE, the UE shall assume that the defined resource elements are not used for PDSCH transmission, subject to some limitations. The UE performs the same measurement/reception on channels/signals except PDSCH, regardless of whether or not the channels/signals collide with ZP CSI-RS. For a non-zero-power CSI-RS configured by the NZP-CSI-RS-Resource IE or by the CSI-RS-Resource-Mobility field in the CSI-RS-ResourceConfigMobility IE, the sequence is generated according a different criteria and mapped to resource elements accordingly.

Different procedures are provided by which the UE reports CSI. The CSI reporting framework can include procedures involving aperiodic CSI reporting, which assumes that the CSI reporting is triggered by DCI format 0_1. However, the procedures can equally apply to CSI reporting triggered by DCI format 0_2, by applying the higher layer parameter reportTriggerSizeDCI-0-2 instead of reportTriggerSize. The time and frequency resources that can be used by the UE to report CSI are controlled by the gNB.

CSI may consist of Channel Quality Indicator (CQI), precoding matrix indicator (PMI), CSI-RS resource indicator (CRI), SS/PBCH Block Resource indicator (SSBRI), layer indicator (LI), rank indicator (RI), L1-RSRP or L1-SINR. For CQI, PMI, CRI, SSBRI, LI, RI, L1-RSRP, and L1-SINR, a UE is configured by higher layers with N≥1 CSI-ReportConfig Reporting Settings, M≥1 CSI-ResourceConfig Resource Settings, and one or two list(s) of trigger states (given by the higher layer parameters CSI-AperiodicTriggerStateList and CSI-SemiPersistentOnPUSCH-TriggerStateList). Each trigger state in CSI-AperiodicTriggerStateList contains a list of associated CSI-ReportConfigs, indicating the Resource Set IDs for channel and, optionally, for interference. Each trigger state in CSI-SemiPersistentOnPUSCH-TriggerStateList contains one associated CSI-ReportConfig.

Each Reporting Setting CSI-ReportConfig is associated with a single downlink BWP (indicated by higher layer parameter BWP-Id) given in the associated CSI-ResourceConfig for channel measurement. The Reporting Setting CSI-ReportConfig contains the following parameter(s) for one CSI reporting band: codebook configuration including codebook subset restriction, time-domain behavior, frequency granularity for CQI and PMI, measurement restriction configurations, and the CSI-related quantities to be reported by the UE, such as the layer indicator (LI), L1-RSRP, L1-SINR, CRI, and SSBRI (SSB Resource Indicator).

The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, L1-RSRP-related or L1-SINR-related quantities to report. The reportFreqConfiguration indicates the reporting granularity in the frequency domain, including the CSI reporting band and if PMI/CQI reporting is wideband or sub-band. The timeRestrictionForChannelMeasurements parameter in CSI-ReportConfig can be configured to enable time domain restriction for channel measurements. Also, the timeRestrictionForInterferenceMeasurements can be configured to enable time domain restriction for interference measurements. The CSI-ReportConfig can also contain CodebookConfig, which contains configuration parameters for Type-I, Type II or Enhanced Type II CSI, including codebook subset restriction and configurations of group-based reporting.

With respect to reporting configurations, the UE calculates CSI parameters (if reported), assuming the following dependencies exists between CSI parameters (if reported):
(i) LI shall be calculated conditioned on the reported CQI, PMI, RI and CRI;
(ii) CQI shall be calculated conditioned on the reported PMI, RI and CRI;
(iii) PMI shall be calculated conditioned on the reported RI and CRI; and
(iv) RI shall be calculated conditioned on the reported CRI.

The Reporting configuration for CSI can be aperiodic (using PUSCH), periodic (using PUCCH) or semi-persistent (using PUCCH, and DCI activated PUSCH). The CSI-RS Resources can be periodic, semi-persistent, or aperiodic. Table I below shows the supported combinations of CSI Reporting configurations and CSI-RS Resource configurations and how the CSI Reporting is triggered/activated for each CSI-RS Resource configuration.

TABLE I

| CSI-RS | Periodic CSI | | |
|---|---|---|---|
| Configuration | Reporting | Semi-Persistent CSI Reporting | Aperiodic CSI Reporting |
| Periodic CSI- | No dynamic | For reporting on PUCCH, the | Triggered by DCI; |
| RS | triggering/ | UE receives an activation | additionally, subselection |
| | activation | command, as described in | indication as described in |
| | | clause 6.1.3.16 of [10, TS | clause 6.1.3.13 of [10, TS |
| | | 38.321]; for reporting on | 38.321] possible as |
| | | PUSCH, the UE receives | defined in Clause |
| | | triggering on DCI | 5.2.1.5.1. |
| Semi- | Not | For reporting on PUCCH, the | Triggered by DCI; |
| Persistent | Supported | UE receives an activation | additionally, subselection |
| CSI-RS | | command, as described in | indication as described in |
| | | clause 6.1.3.16 of [10, TS | clause 6.1.3.13 of [10, TS |
| | | 38.321]; for reporting on | 38.321] possible as |
| | | PUSCH, the UE receives | defined in Clause |
| | | triggering on DCI | 5.2.1.5.1. |
| Aperiodic | Not | Not Supported | Triggered by DCI; |
| CSI-RS | Supported | | additionally, subselection |
| | | | indication as described in |
| | | | clause 6.1.3.13 of [10, TS |
| | | | 38.321] possible as |
| | | | defined in Clause |
| | | | 5.2.1.5.1. |

Periodic CSI-RS is configured by higher layers. For semi-persistent reporting on PUSCH, a set of trigger states are higher layer configured by CSI-SemiPersistentOnPUSCH-TriggerStateList, where the CSI request field in DCI, scrambled with SP-CSI-RNTI, activates one of the trigger states. A UE is not expected to receive a DCI scrambled with SP-CSI-RNTI activating one semi-persistent CSI report with the same CSI-ReportConfigId as in a semi-persistent CSI report, which is activated by a previously received DCI scrambled with SP-CSI-RNTI.

The present disclosure builds upon the recognition that a RIS can be configured with the help of control information from the network, on the control link (C-link) between the RIS and gNB, for efficient reflection of the signal. The control information may include on/off time as well as spatial information for beamforming. The RIS can provide feedback information and/or can report the measured channel of the control link between the RIS and gNB. In order to optimize the reflection coefficients of RIS elements to reflect the signal towards a UE, the gNB may need to rely on the UE-provided CSI report. However, with conventional applications of RIS, the CSI report from the UE contains the effect of both channels (gNB-RIS+RIS-UE) as a cascaded channel. Thus, finding the optimal configuration for the RIS to reflect DL/UL signal to/from the UE is difficult. With the conventional applications, the gNB may need to perform a training stage with the RIS to calibrate the connection with the UE. For example, the gNB may need to send many CSI-RS beams for training and calibration.

The present disclosure addresses and eliminates these and other limitations in the conventional implementation of the RIS as an intermediary network device for signals transmitted to and from a UE. According to one or more aspects of the present disclosure, the RIS is configured by the gNB to report the CSI of the backhaul link and of the access link separately, in addition to the CSI of the C-link. Three different aspects of the disclosure are presented, each corresponding to one of the three devices operating and/or performing specific functions to enable the features of the disclosure. According to a first aspect of the disclosure, a network device, such as an gNB, performs the RIS configuration features provided by the disclosure. According to a second aspect of the disclosure, a controller of a RIS performs the RIS-implemented features of the disclosure. And, according to a third aspect of the disclosure, a communication device or UE performs the UE-implemented features of the disclosure. The devices operate collaboratively (i.e., via sharing of configuration signals, CSI reports, and other communication with each other) to provide the overall functions provided herein.

Various aspects of the disclosure involve the configuration for the RIS to separately measure the two parts of the forward link, the backhaul-link and the access link. The configuration of the RIS supports/includes the following processes: (i) measuring the backhaul link based on configuration from gNB of CSI-RS associated with CSI-RS of the target UE; (ii) measuring the access link based on configuration from gNB of SRS resources associated with SRS from the target UE; (iii) configuration with sidelink resources to be used for reference signal exchange between the RIS and the UE to measure the access link; and (iv) configuration for reporting CSI(s). Additional aspects further involve the configuration of the UE to report CSI of the access link between the RIS and the UE.

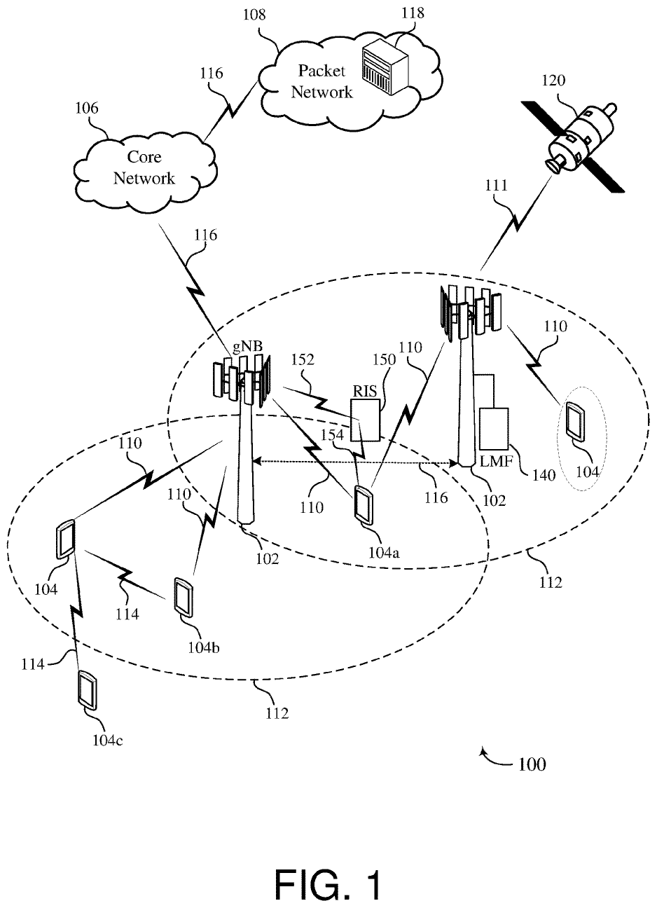

FIG. 1 illustrates an example of a wireless communications system 100 enabling wireless communication and which supports the various communication and other features presented herein, in accordance with aspects of the present disclosure. Specifically, the wireless communications system of FIG. 1 supports configuring a reconfigurable intelligent surface with optimal parameters to reflect downlink and uplink signals to and from a communication device, such as a UE, in accordance with aspects of the present disclosure.

The wireless communications system 100 may include one or more network devices 102, one or more UEs 104 (which is inclusive of all UEs with leading reference numerals 104, e.g., 104a, 104b, 104c), a core network 106, and a packet data network 108. According to one aspect of the disclosure, the wireless communications system 100 also includes one or more reconfigurable intelligent surfaces 150. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a New Radio (NR) network. In other implementations, the wireless communications system 100 may be a combination of a 4G network and a 5G network. The wireless communications system 100 may support radio access technologies beyond 5G, or other suitable radio access technology including Institute of Electrical and Electronics Engineers (IEEE) 802.11 (Wi-Fi), IEEE 802.16 (WiMAX), IEEE 802.20. Additionally, the wireless communications system 100 may support technologies, such as time division multiple access (TDMA), frequency division multiple access (FDMA), or code division multiple access (CDMA), etc.

The one or more network devices 102 may be dispersed throughout a geographic region to form the wireless communications system 100. One or more of the network devices 102 described herein may be, may include, or may be referred to as a network node, a base station, a network element, a radio access network (RAN), a base transceiver station, an access point, a NodeB, an eNodeB (eNB), a next-generation NodeB (gNB), a network device, or other suitable terminology. A network device 102 and a UE 104 may communicate via a communication link 110, which may be a wireless or wired connection. For example, a network device 102 and a UE 104 may wirelessly communicate (e.g., receive signaling, transmit signaling) over the air (Uu) interface. According to the present disclosure, the network device 102 and a UE 104a may wirelessly communicate via the RIS 150, which operates as a connecting intermediary device. RIS 150 connects via backhaul link 152 to network device 102 and via access link 154 to UE 104.

A network device 102 may provide a geographic coverage area 112 for which the network device 102 may support services (e.g., voice, video, packet data, messaging, broadcast, etc.) for one or more UEs 104 within the geographic coverage area 112. For example, a network device 102 and a UE 104 may support wireless communication of signals related to services (e.g., voice, video, packet data, messaging, broadcast, etc.) according to one or multiple radio access technologies. In some implementations, a network device 102 may be moveable, for example, a satellite 120 associated with a non-terrestrial network that communicates via a link 111 to network devices 102. In some implementations, different geographic coverage areas 112 associated with the same or different radio access technologies may overlap, but the different geographic coverage areas 112 may be associated with different network devices 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. The one or more UEs 104 (e.g., UE 104a and UE 104b) can be located within a serving cell (i.e., in-coverage) of a respective network device (gNB) 102. At least one or more UEs 104 (e.g., UE 104c) may be located outside of a serving cell (i.e., out-of-coverage). A UE 104 may include or may be referred to as a mobile device, a wireless device, a communication device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

Some examples of UEs 104 are illustrated in FIG. 1. The one or more UEs 104 may be devices in different forms or having different capabilities. A UE 104 may be capable of communicating with various types of devices, such as the network devices 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network devices 102 or UEs 104, or RIS 150, which may act as relays in the wireless communications system 100.

A UE 104 may also be able to support wireless communication directly with other UEs 104 or intermediary device, e.g., RIS 150, over a communication link 114. For example, a UE 104 may support wireless communication directly with another UE 104 or with RIS 150 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 (or with the RIS 150) over a PC5 interface. PC5 refers to a reference point where the UE 104 directly communicates with another UE 104 (or the RIS 150) over a direct channel without requiring communication with the network device 102.

A network device 102 may support communications with the core network 106, or with another network device 102, or both. For example, a network device 102 may interface with the core network 106 through one or more backhaul links 116 (e.g., via an S1, N2, or another network interface). The network devices 102 may communicate with each other over the backhaul links 116 (e.g., via an X2, Xn, or another network interface). In some implementations, the network devices 102 may communicate with each other directly (e.g., between the network devices 102) via a backhaul link 116. In some other implementations, the network devices 102 may communicate with each other indirectly (e.g., via the core network 106). In some implementations, one or more network devices 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

In some implementations, a network entity or network device 102 may be configured in a disaggregated architecture, which may be configured to utilize a protocol stack physically or logically distributed among two or more network entities or network devices 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity or network device 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities or network devices 102 in a disaggregated RAN architecture may be co-located, or one or more components of the network entities or network devices 102 may be located in distributed locations (e.g., separate physical locations). In some implementations, one or more network entities or network devices 102 of a disaggregated RAN architecture may be implemented as virtual units (e.g., a virtual CU (VCU), a virtual DU (VDU), and/or a virtual RU (VRU)).

The split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layers (e.g., a layer 3 (L3), a layer 2 (L2)) functionality and signaling (e.g., Radio Resource Control (RRC), service data adaptation protocol (SDAP), and Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities or network devices 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more network devices 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity or network device 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., with one or more network functions of the core network 106).

In the wireless communications system 100, the network entities or network devices 102 (and the RIS 150) and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities or network devices 102 and the UEs 104 may support different resource structures. For example, the network entities or network devices 102 and the UEs 104 may support different frame structures. In some implementations, such as in 4G, the network entities or network devices 102 and the UEs 104 may support a single frame structure. In some other implementations, such as in 5G and among other suitable radio access technologies, the network entities or network devices 102 and the UEs 104 may support various frame structures (i.e., multiple frame structures). The network entities or network devices 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHZ-114.25 GHZ), FR4a or FR4-1 (52.6 GHZ-71 GHz), and FR5 (114.25 GHz-300 GHz). In some implementations, the network entities or network devices 102 and the UEs 104 may perform wireless communications over one or more of the operating frequency bands. In some implementations, FR1 may be used by the network entities or network devices 102 and the UEs 104, among other equipment or devices for cellular communications traffic (e.g., control information, data). In some implementations, FR2 may be used by the network entities or network devices 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

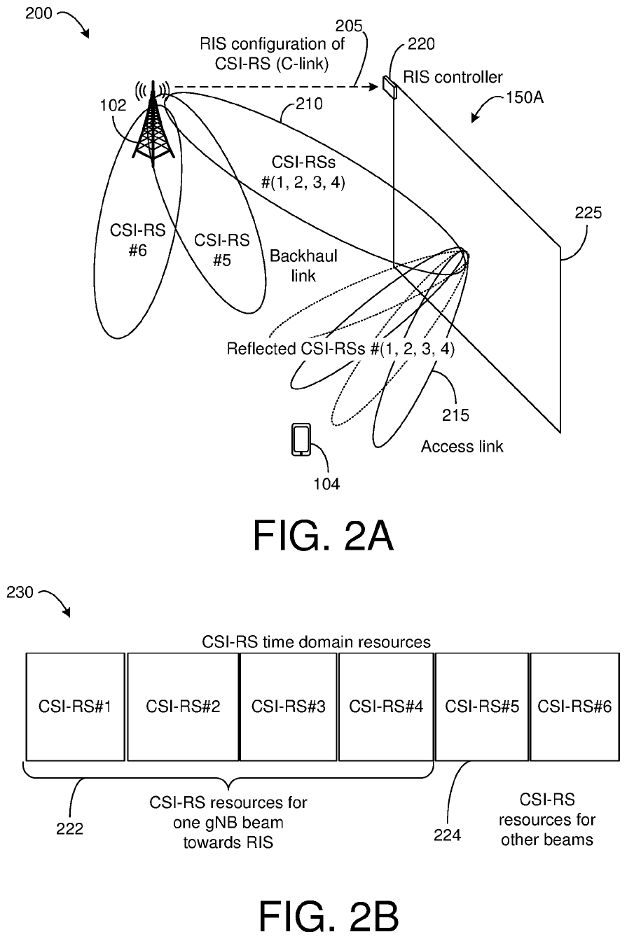

FIG. 2A presents a diagram of an example communication system showing CSI-RS transmission to a user equipment (UE) via RIS elements, which reflect a received CSI-RS signal from the gNB as multiple CSI-RS beams towards the UE, according to prior art. As presented by FIG. 2A, RIS 150A includes RIS controller 220, which represents the processing components of RIS 150. RIS 150A also include RIS reflective surface 225, which reflects impinging signals at different angles based on characteristics (e.g., reflection coefficients) of the incoming signal. In FIG. 2A, a C-link 205 is provided between gNB 102 and RIS Controller 220 of RIS 150A. C-link 205 is utilized to exchange control information and feedback between the gNB 102 and RIS controller 220. FIG. 2A presents an example of the forward link (210+215) that is established as a Uu link between gNB 102 and UE 104 being divided into two links, a backhaul link (gNB-RIS) and an access link (RIS-UE). In order to transmit multiple CSI-RS beams to a UE 104 via RIS 150A, the gNB 102 needs to configure a larger number of CSI-RS resources (i.e., a larger number than required when not utilizing the RIS), since for each backhaul beam from gNB 102, multiple reflected beams at RIS 150A are needed to generate the spatially distributed CSI-RS beams. FIG. 2B illustrates an example collective 230 of CSI-RS time domain resources 222, with multiple CSI-RS resources 224 required for a single gNB beam being transmitted towards the RIS, as presented within the prior art communication system of FIG. 2A. As shown in FIGS. 2A and 2B, four CSI-RS resources are required to be transmitted for the single beam 210 on the backhaul link to the RIS. These are then reflected as four separate beams 215 on the access link for selection by the UE 104.

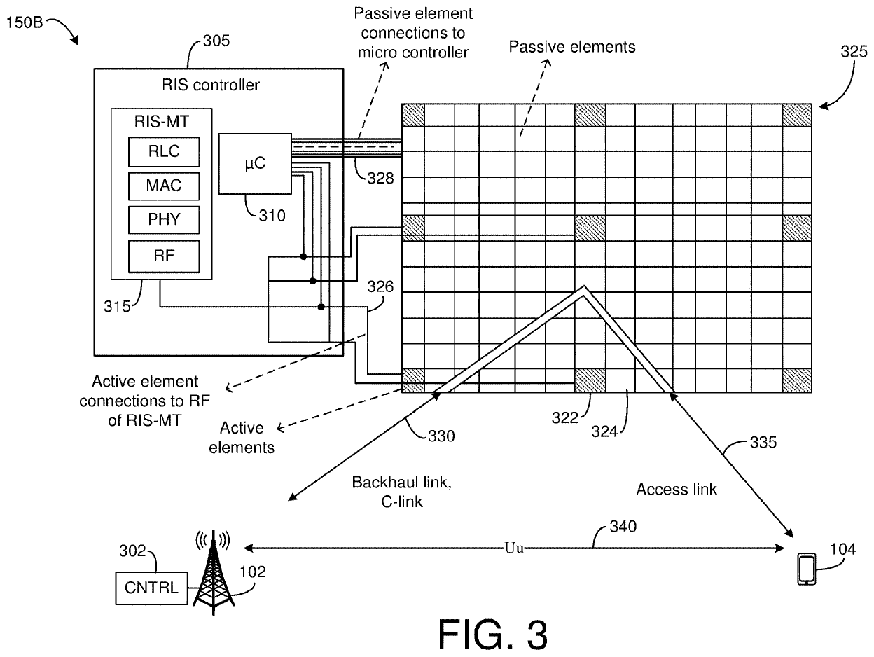

FIG. 3 illustrates example components of a RIS 150B, including the RIS controller 305 and active RIS elements 322 that are configurable, based on configuration messages provided by/from a gNB controller 302, to enable the RIS 150B to provide optimal uplink and downlink signal communication with a communication device, in accordance with aspects of the present disclosure. RIS 150B is presented with a different reference numeral from RIS 150A of FIG. 2A to indicate that RIS 150B is functionally distinguishable from the prior art RIS 150A. Outside of the FIG. 2A description, all other references to RIS 150 or 150B that is associated with a description of the novel features of the disclosure, as assumed to refer to RIS 150B and features and functionality associated therewith. RIS 150 and RIS 150B are therefore utilized interchangeably hereinafter.

RIS controller 220 represents the processing components of RIS 150B. As shown by FIG. 3, RIS controller 305 has multiple functional modules providing different operating functions. According to the illustrated embodiment, RIS controller 220 can include a signaling module 315 that can communicate with the gNB 102 to receive side control information and to send feedback to the gNB 102 on the C-link 205 established between the RIS controller 220 and gNB 102/gNB controller 302. According to one or more implementations, RIS controller 220 may reuse the functionality of a UE in terms of receiving control information and sending feedback to the gNB 102. According to the illustrated embodiment, RIS controller 220 can have a second module, which includes a microcontroller 310, utilized to configure the RIS elements 322, 324, based on side control information that is received by the signaling module 315 and is available at MAC/RLC or higher layer of the protocol(s) utilized by the signaling module 315.

RIS 150B also includes RIS reflective surface 325, which includes a collection of active elements 322 and passive elements 324. Microcontroller 310 is electrically and communicatively couple to and can individually control each active element 322 of RIS reflective surface 325 via a respective active element connection 326. The active element connection 326 is also communicatively coupled to signaling module, enabling configuration of the active element based on signal characteristics provided by/from signaling module 315. Microcontroller 310 is also communicatively coupled to the passive elements of RIS reflective surface 325 via passive element connections 328.

Within the description of the disclosure, references to RIS 150/150B and the features provided by RIS 150/150B are assumed to include the combination of features and operations associated with both RIS controller 305 and active and passive elements 322, 324 of RIS reflective surface 325 of RIS 150B. According to the disclosure, the gNB 102 transmits RIS configuration of the CSI-RS to the RIS controller 220 via the C-link (330). The RIS configuration enables the RIS to support the separate configuration and reporting of the backhaul link 330 and the access link 335 of the forward link to the UE 104. In one or more embodiments, a direct Uu link 340 can also be established between the gNB 102 and the UE 104, independent of the RIS 150.

With continuing reference to FIG. 3, aspects of the present disclosure provide embodiments by which the RIS 150B is utilized to report (i) the CSI of the C-link and to separately report (ii) the CSI of the backhaul link and (iii) the CSI of the access link. Accordingly, separated channel information of the backhaul link and the access link are provided to the gNB 102, enabling the gNB 102 to better optimize the operations of the RIS 150B. The disclosure recognizes that part of the RIS elements (e.g., the active elements distributed on the RIS reflective surface) can be connected to RF chains (available via the connection to the signaling module 315) and the baseband processor, such that at least partial information of the backhaul link 330 and access link channel 335 can be measured at the RIS 150B. The elements 322 can be connected to separate RF chains and processor (as shown in FIG. 3). According to one or more embodiments of the disclosure, the active elements 322 are connected to the RF chain of the RIS signaling module 315 and used as an antenna for the communication between RIS controller 305 and gNB 102.

According to a first aspect, the gNB configures the RIS 150B with separate CSI-RS and CSI reports containing CSI feedback of the backhaul-link and the C-link. In one or more embodiments, the gNB configures the RIS with reference signals to separately measure the channel on the backhaul link (i.e., the link between gNB and RIS) and on the access link (i.e., the link between RIS and UE) in situations where the RIS supports a set of active elements that are connected to the RF chain (of signaling module 315) and to the base band processor (represented by microcontroller 310). In one embodiment, the gNB may request the RIS controller to send a capability report, where the report contains information of the number of supported active elements for measurement, the distribution of these active elements on the RIS reflective surface(s), and whether these active elements are connected to the RF chain(s) of the RIS signaling module 315. In one or more embodiments, the capability report can be included as a part of the RF capability sent by RIS signaling module 315 during the attach procedure.

In one or more embodiments, the gNB 102 may send configuration for CSI-RS to the RIS 150B, where the configuration contains (i) a set of CSI-RS resources for measuring the C-link beam(s) and (ii) another set of CSI-RS resources for the CSI-RS configured for the intended UE if the backhaul beam and the C-link beam are different. The gNB 102 configures RIS signaling module 315 with UL resources to send the CSI reports. In one or more embodiments, the legacy procedure for sending the CSI of the C-link can be used, while additional resources are configured to send the CSI information of the backhaul link that is retrieved from measuring the channel on the UE-configured CSI-RS. According to one or more embodiments, the CSI report of the backhaul link may contain CRI-SINR, CRI-RSRP, CRI-CQI, CRI-RI, or a combination thereof. The CSI report of the backhaul link may also contain the estimated channel coefficients. According to one or more embodiments, the RIS signaling module 315 is configured to report the CSI of both the C-link and/or backhaul link using UCI over PUCCH/PUSCH of the UL of the C-link. In instances where the gNB 102 uses the same beam for both the C-link and backhaul link, the RIS signaling module 315 is configured to send a single report. According to one or more embodiments, the reported CSI information can be per active element 322 of the RIS 150B. As an example, the reported CSI information can be per active element 322 if the active elements 322 are connected to different RF chains at the RIS signaling module 315 or if the CSI being reported is just the power measured at each active element 322. Upon receiving the channel information for backhaul link and/or C-link, the gNB 102 can perform signal processing schemes to retrieve the complete channel(s) on all RIS elements including passive and active elements using, for example, Artificial Intelligence/Machine Learning (AI/ML) schemes.

Another aspect of the disclosure involves the gNB 102 configuring RIS 150B to perform measurement and provide feedback of the access-link channel. In one embodiment, gNB configures the RIS signaling module 315 with resources for receiving and measuring the reference signals from the target UE (e.g., SRS resources) during the transmission of the UE in the UL slots, in order to measure and/or estimate the access link channel. To enable this feature, according to one embodiment, the RIS signaling module 315 may need to be configured with different SFI (i.e., different TDD switching than the one configured for the UE 104). Accordingly, during the UL of the UE 104, the RIS signaling module 315 is also configured to receive SRS signal or other UL reference signals. The RIS signaling module 315 is configured with UL resources to signal the channel of the measured SRS to the gNB 102 using C-link. According to one or more embodiments, the feedback report may include the quality of the UE UL channel, an indication of the measured SRS beams (e.g., SRI), and/or the detailed coefficients of the channel per active element.

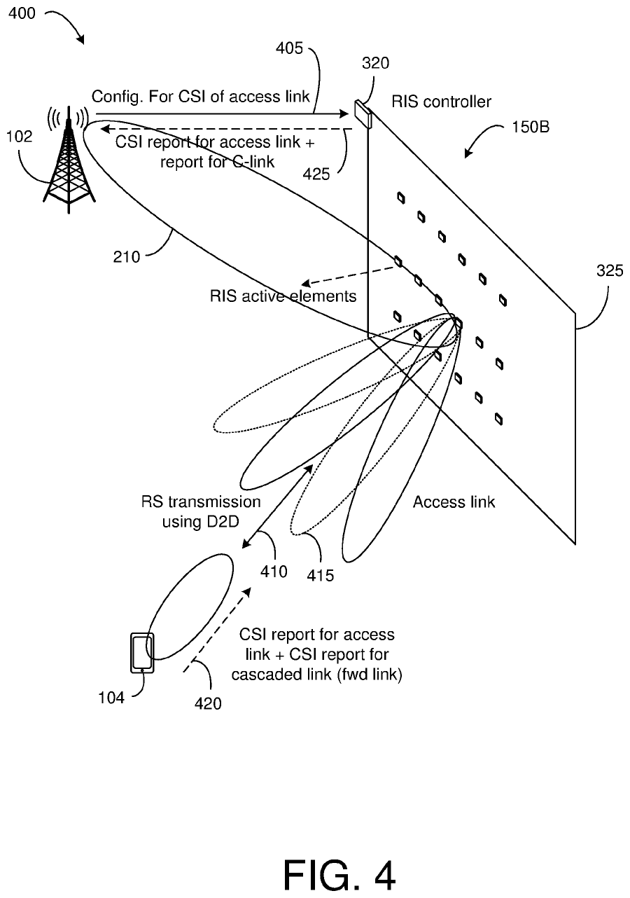

In accordance with another aspect of the disclosure and according to one or more alternate embodiments, the gNB 102 configures the RIS 150B and UE 104 to establish a connection (e.g., a sidelink connection) and configures the RIS 150B with the resources for the sidlelink reference signals. FIG. 4 illustrates communication system 400 providing example CSI reporting for the access link using device-to-device sidelink communication (410) between the RIS and the UE, in accordance with aspects of the present disclosure. The RIS 150B is configured by the gNB 102 with UL resources in the C-link 405 to report the channel in the sidelink 410. Upon receiving the measured channel of the access link on the active elements, the gNB 102 retrieves the channel for the rest of the active elements to optimize the RIS 150B for the cascaded channel of the forward link.

According to another embodiment, in the case of non-transparent mode of RIS 150B to UE 104, the gNB 102 configures the RIS 150B to send a reference signal to the target UE 104, by, for example, a sidelink 410 connecting the UE 104 with the RIS signaling module (315). And, the gNB 102 configures the UE 104 to measure the access channel 415 and report the measurement to the gNB 102. Upon receiving the measured channel information of the access link (415) sent from the active elements 322, the gNB 102 retrieves the channel for the rest of the active elements. The gNB 102 may combine the UE reports (e.g., the CSI of Uu link 420 from gNB via RIS and the CSI of the access link 415 from RIS signaling module 315) in order to retrieve the complete access link channel.

In one or more embodiments, the gNB 102 estimates the backhaul and the access links in a two-stage framework. In the first stage, the gNB 102 configures the RIS 150 to transmit, to the gNB 102, CSI-RSs, which can be used to estimate the CSI of the backhaul link. In the second stage, the gNB 102 configures the UE 104 to transmit SRSs, and the gNB 102 configures the RIS 150 to reflect SRSs towards the gNB 102 using some configured CSI-RSs. The gNB 102 can use the CSI measurements obtained in the first stage to estimate the access link in the second stage. Since the backhaul link changes very slowly compared to the access link, the gNB 102 can perform the first stage less frequently compared to the second stage. The frequency of performing the second stage can be adapted to the UE mobility and rotations, for example.

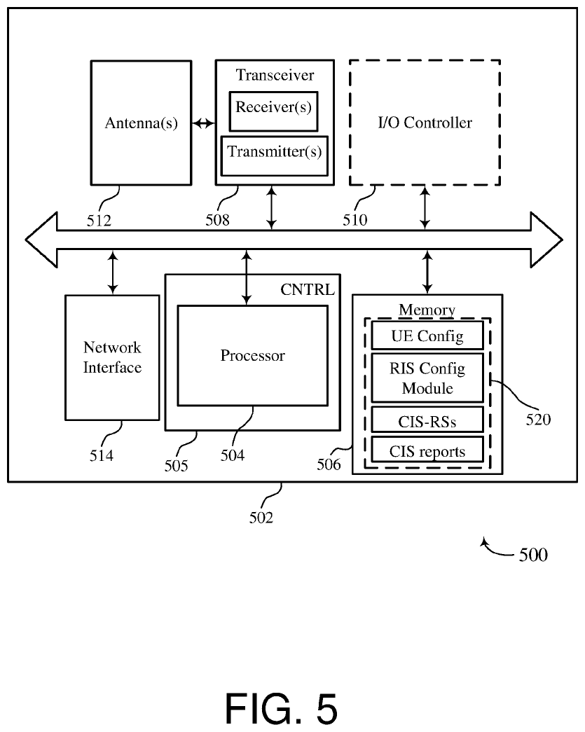

As presented in FIGS. 1-4, the gNB 102 is a network device having gNB controller 302 that provides configuration messages to configure an intermediary network device, such as RIS 150B, and a UE 104 to enable the performance of several of the described features and the network device functionality of the disclosure. According to a first aspect of the disclosure, which encompasses processes at/on/by a network device for wireless communication, the network device includes a transceiver having at least one transmitter and at least one receiver that enable the network device to communicate with other devices via one or more networks and corresponding network protocols. The device includes a memory having program code for enabling the network device to support the features and functions described herein. The network device has a controller communicatively coupled to the memory and the transceiver. Physical components of an example network device 502 are illustrated in FIG. 5, which is now described.

FIG. 5 illustrates an example of a block diagram 500 of a network device 502 that supports wireless communication and the configuring of an RIS and a UE, in accordance with aspects of the present disclosure. The network device 502 may support wireless communication with one or more other network entities or network devices 52, RISs 150, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In one embodiment a controller (505) includes the processor 504 and can include other components. The controller 505 configures the device 502 to perform the functionality of the present disclosure. The controller 505 is communicatively coupled to the memory 506 to execute program code. In one embodiment, the controller 505 may include dedicated memory that is a portion of memory 506 but solely accessible by the processor 504. In some implementations, the processor 504 and the memory 506 coupled with the processor 504 may be configured to perform one or more of the functions as a controller 505 described herein (e.g., executing, by the processor 504, instructions stored in the memory 506).

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

In an example, the controller 505 may support wireless communication at the device 502 in accordance with examples as disclosed herein. In one or more embodiments, the memory 506 stores various program modules having code and instructions (collectively code 520) that, when executed by the processor 504, configures the device 502 to perform the various communication and configuration functions described herein, among other features.

The I/O controller 510 may manage input and output signals for the device 502. The I/O controller 510 may also manage peripherals not integrated into the device 502. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor 504. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally using one or more receivers and one or more transmitters, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512. The device 502 also includes a network interface 514.

According to the first aspect of the disclosure involving processes performed by and on/at the above network device, in one or more embodiments, the controller transmits, via the transceiver to a second controller of the reconfigurable intelligent surface, a first configuration message comprising separate channel state information reference signals for separately measuring a channel of (i) a backhaul link between the reconfigurable intelligent surface and the network device and for (ii) an access link between the user equipment and the reconfigurable intelligent device. The controller transmits, via the transceiver to the second controller, a second configuration message comprising an indication of resources that the second controller should utilize to report the channel state information on an uplink channel between the reconfigurable intelligent surface and the network device, the resources utilized to send both channel state information for the backhaul link and for the access link.

According to one or more embodiments, the controller transmits, to the user equipment (UE), a configuration for an access link reference signal transmitted by the RIS. It is appreciated that in alternate embodiments, where there is a direct Uu channel established between the gNB and UE, the configuration can be sent directly to the UE, in which case the aforementioned process is omitted. The controller receives from the UE, on a Uu connecting the UE and the network device, a channel state information (CSI) report of the access link between the RIS and the UE.

In one or more embodiments, the controller receives, from the RIS, the CSI for at least one of the backhaul link and the C-link, wherein the CSI is received on UCI via one of PUCCH or PUSCH in one of: (i) a dedicated CSI report of a forward link comprising the backhaul link and the access link; or (ii) a combined CSI report comprising the dedicated CSI report and a CSI of the C-link. The controller performs one or more signal processing schemes to retrieve one or more complete channel(s) on all RIS elements.

In one or more embodiments, the controller receives the CSI as individual CSI reports for each active element of the RIS, in response to one of (a) each active element being connected to different RF chains or (b) a RS within each of the individual CSI reports corresponding to a power measured for an associated active element.

In one or more embodiments, the controller determines, from a received RIS capability report, that the RIS supports a set of active elements that are connected to a radio frequency (RF) chain and a base band processor. The controller initiates a transmission of the first configuration message and the second configuration message in response to determining that the RIS supports the set of active elements.

In one or more embodiments, the controller transmits, to the RIS, a request for the RIS capability report, the RIS capability report including information of a number of supported elements for measurement, a distribution of the supported elements on the RIS in order for the network device to retrieve a complete channel on passive elements, and whether the supported elements are connected to the RF chain(s) of the RIS.

In one or more embodiments, the controller transmits the request as an indication within the first configuration message. In one or more alternate embodiments, the controller receives the RIS capability report from the RIS signaling module during an attach procedure.

In one or more embodiments, the controller identifies that a backhaul beam and a C-link beam connecting the network device to the RIS are different. The controller, in response to the backhaul beam and the C-link beam being different, incorporates within the first configuration message a first set of CSI reference signal (RS) resources for measuring a C-link beam, and a second set of CSI-RS resources for the CSI-RS configured for the UE.

According to one or more embodiments, the second configuration message configures the RIS with uplink resources to send CSI reports of the C-link and configures additional resources to transmit CSI information of the backhaul link retrieved from measuring a channel on a UE configured CSI-RS.

According to one or more embodiments, the first configuration message configures the RIS with resources for receiving and measuring the reference signals from the UE during a transmission of the UE in one or more uplink slots to enable the network device to estimate the access link channel. The controller combines a first CSI of the Uu link from the UE, via the RIS, to the network device, and a second CSI of the access link from the UE to the RIS to generate a complete access link channel.

In one or more embodiments, the controller incorporates, within the first configuration message, one or more configurations, which triggers one or more of RIS processes from among: (i) configures the RIS to establish a device-to-device connection with the UE; (ii) configures the RIS with resources for sidelink reference signals comprising information related to reference signals to be exchanged between the RIS and the UE in a device-to-device communication; and (iii) transmits to the UE, via the RIS, resources of device-to-device reference signals transmitted by the RIS on active elements of the RIS.

According to one or more embodiments, the first configuration message configures the RIS with uplink resources to signal, via the C-link to the network device, a channel of a measured sounding reference signal (SRS) transmitted by the UE in the uplink (UL) to the network device. With these embodiments, in measuring the channel state of the access link between the UE and the RIS, the reference signal resources can be the resources of SRS transmitted by the UE to the gNB in the UL and measured in between at the RIS to obtain the access link channel.

In one or more embodiments, the controller receives the channel of the measured SRS of the access link on the active elements, and, in response to receiving the channel of the measured SRS, the controller retrieves the channel for a remainder of passive elements to optimize the RIS for a cascaded channel of a forward link.

According to one or more embodiments, the first configuration message comprises UE resource configuration and the first configuration message configures the RIS to send reference signals to the UE and further configures the UE to measure the access channel and to report, via a Uu link to the network device, a measurement of the access channel between the RIS and the UE.

According to one or more embodiments, the second configuration message comprises information for a type, a granularity, and a PHY channel used to report the CSI information of the backhaul link and the access link.

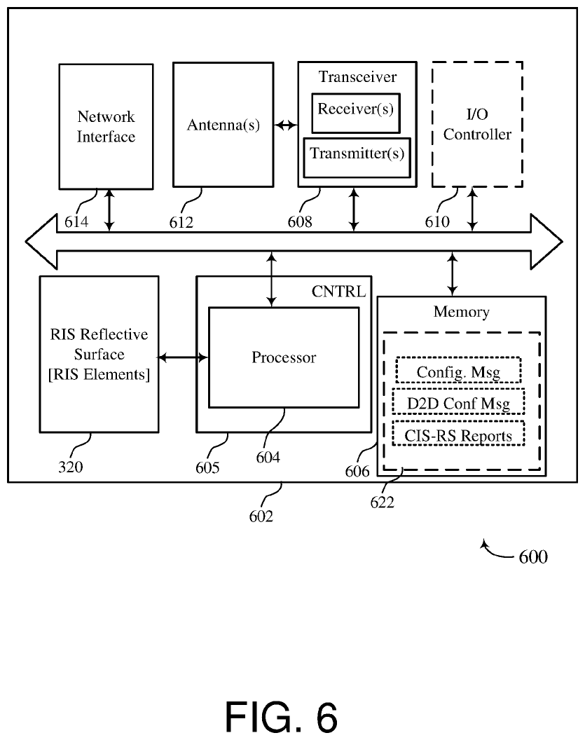

The second aspect of the disclosure involves processes performed at an intermediary network device, providing a RIS 150. FIG. 6 illustrates an example of a block diagram 600 of an intermediate network device 602 that provides an RIS (150B), which is configured to support wireless communication and other described features involving a communication device, such as a UE 104, in accordance with aspects of the present disclosure. Important aspects of the hardware component makeup of an example RIS 150B are presented with reference to FIG. 3, which is described above. With the present illustration, controller 605 can be synonymous with or perform similar features as RIS controller 305 (FIG. 3). Controller 605 is configured/programmed with firmware and application code to enable the device 602 to operate or perform the specific functions of the example RIS 150, as described herein. The intermediary network device 602 can include similarly named physical components as network device 502 of FIG. 5. These components are provided with a different leading reference numeral, but can be similarly described as with the description of FIG. 5. Thus processor 604, presented within controller 605, is communicatively coupled to memory 606, transceiver 608 having antennas 612 for wireless communication, I/O controller 610, and network interface 614. Intermediary network device 602 further includes RIS reflective surface 320 with RIS elements 322, 324 (FIG. 3). The interconnected components provide the functionality of a RIS 150B based on firmware configuration and execution of program code 622 of one or more specific modules within memory 606. Thus, the device memory 606 may include the relevant program modules 622 with code for the device controller to perform each of the RIS-based processes described herein, depending on which function the RIS 150B is performing in the different scenarios described.

According to the second aspect of the disclosure presented with reference to FIG. 6, an intermediary device for wireless communication provides the features of a RIS, such as RIS 150B of FIG. 3. The device includes a physical surface (reflective surface 320) having active elements and passive elements of a reconfigurable intelligent surface 150B. The device includes a controller module communicatively coupled to at least each of the active elements within the reconfigurable intelligent surface to provide a reconfigurable intelligent surface terminal (generally RIS 150). The controller module includes a transceiver having at least one transmitter and at least one receiver that enable a controller 605 to communicate with network devices via one or more networks. The RIS includes a wireless communication interface that enables the device to communicate with a user equipment via a device-to-device communication link. The RIS includes a memory having program code for enabling the device to operate as the reconfigurable intelligent surface.

The RIS includes a controller communicatively coupled to the memory, the communication interface, and the transceiver. The controller receives, from a network device via at least one communication link established through a network, a first configuration message comprising separate channel state information reference signals for separately measuring a channel of (i) a backhaul link between the reconfigurable intelligent surface and the network device and for (ii) an access link between the user equipment and the reconfigurable intelligent device. The controller receives, from the network device, a second configuration message comprising an indication of resources that the second controller should utilize to report the channel state information on an uplink channel between the reconfigurable intelligent surface and the network device, the resources utilized to send both channel state information for the backhaul link and for the access link. The controller reports separate CSI of the backhaul link and of the access link on an uplink of a C-link communicatively connecting the device with the network device.

In one or more embodiments, the controller identifies whether a current configuration of the device provides a same beam being utilized for both the C-link and the backhaul link. The controller transmits a single CSI report in response to the configuration of the device providing for the same beam being utilized for both the C-link and the backhaul link. The controller, in response to a different beam being utilized for the C-link and for the backhaul link, reports a respective CSI of both the C-link and a forward link comprising the backhaul link and the access link.

In one or more embodiments, the controller transmits to the user equipment (UE), a configuration for measuring the access link and reporting an access link reference signal. The controller receives, from the UE, a channel state information (CSI) report of the access link between the device and the UE. The controller forwards the received CSI report to the network device as an access link CSI report.

In one or more embodiments, the controller forwards, to the network device, the CSI for at least one of the backhaul link and the C-link. The network device utilizes the received CSI to performs one or more signal processing schemes to retrieve one or more complete channel(s) on all RIS elements. In one or more embodiments, the controller forwards, to the network device, the CSI as individual CSI reports for each active element of the RIS, in response to one of (a) each active element being connected to different RF chains or (b) a RS within each of the individual CSI reports being a power measured per an associated active element.

In one or more embodiments, the controller forwards, to the network device, a RIS capability report, which indicates that the RIS supports a set of active elements that are connected to the radio frequency chain and a base band processor, the RIS capability report triggering a transmission of the first configuration message and the second configuration message by the network device, in response to determining that the RIS supports the set of active elements.

In one or more embodiments, the controller receives, from the network device, a request for the RIS capability report, the RIS capability report comprising information of a number of supported elements for measurement, a distribution of the supported elements on the RIS, and whether the supported elements are connected to the radio frequency (RF) chain(s) of the RIS. The controller forwards the RIS capability report in response to receiving the request. In one or more alternate embodiments, the controller transmits the RIS capability report to the network device during an attach procedure with the network device.

In one or more embodiments, the controller the controller, in response to a backhaul beam and the C-link beam being different: measures a C-link beam utilizing a first set of CSI reference signal (RS) resources from the first configuration message; and measures the CSI-RS configured for the UE utilizing a second set of CSI-RS resources.

According to one or more embodiments, the first configuration message configures the device with resources for receiving and measuring the sounding reference signals (SRS) from the UE during a transmission of the UE in one or more uplink slots to enable the network device to estimate the access link channel.

In one or more embodiments, the controller receives, from the network device, a configuration message comprising one or more configurations for the device and the UE to establish a device-to-device connection. The controller configures the device with resources for sidelink reference signals comprising information related to reference signals to be exchanged between the RIS and the UE in a device-to-device communication. The controller establishes the device-to-device connection with the UE. The controller transmits, to the UE, resources of device-to-device reference signals transmitted by the RIS on active elements of the RIS. The controller provides the resources for reference signal for use within a sidelink channel with the UE.

According to one or more embodiments, the first configuration message includes UE resource configuration and the first configuration message configures the RIS to send reference signals to the UE to configure the UE to measure the access channel and report, via a Uu link to the network device, a measurement of the access channel between the RIS and the UE. The controller transmits, to the UE, the reference signals with an indication to measure the access channel and to report, via the Uu link to the network device, the measurement of the access channel between the RIS and the UE.

In one or more embodiments, the controller retrieves, from the second configuration message, information for a type, a granularity, and a PHY channel used to report the CSI information of the backhaul link and the access link.

In one or more embodiments, the controller receives the CSI-RS of the access link from the UE, determines the CSI of the backhaul link, generates a forward link CSI report including the CSI of both the backhaul link and the access link. The controller further determines the CSI of the C-link, generates a combined CSI report comprising both the forward link CSI report and the CSI of the C-link, and forwards the combined CSI report to the network device on an UCI over the C-link via one of PUCCH or PUSCH.

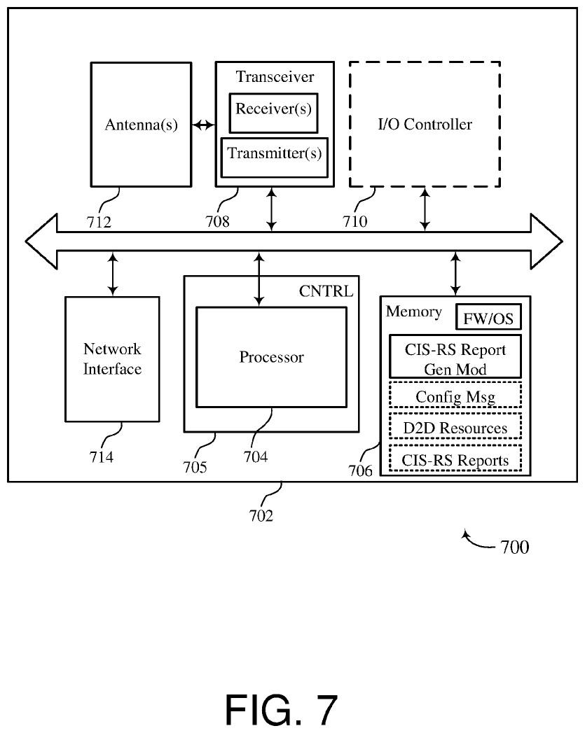

FIG. 7 illustrates an example of a block diagram 700 of a communication device 702 that supports wireless communication and SL communication with a reconfigurable intelligent surface for access channel state reporting, in accordance with aspects of the present disclosure. According to the third aspect of the disclosure, a communication device 702, such as a UE 104 (FIG. 1), is configured/programmed with firmware and applications to enable the device to operate as or perform the specific functions of the UE 104, as described herein. Communication device 702 can include similarly named physical components as network device 502 of FIG. 5. These components are provided a different leading reference numeral, but can be similarly described, as with the description of FIG. 5. Thus, communication device 702 includes processor 704, presented within controller 705, that is communicatively coupled to memory 706, transceiver 708 having antennas 712 for wireless communication, I/O controller 710, and network interface 714. The interconnected components provide the functionality of the described UE, based on firmware configuration and execution of program code of one or more specific modules within memory 706. Accordingly, the device memory 706 may include the relevant program modules having executable code for the device controller to perform each of the UE-based processes described herein, depending on which function the UE is performing in the different scenarios described.

Thus, as one aspect, the disclosure provides a communication device for wireless communication. The communication device includes a transceiver comprising at least one transmitter and at least one receiver that enable the communication device to communicate with network devices via one or more networks and corresponding network protocols. The device includes a wireless communication interface that enables the device to communicate with at least one second device via a device-to-device communication link, the at least one second device comprising a reconfigurable intelligent surface. The communication device includes a memory having program code for enabling the device to operate as a user equipment. The communication device further includes a controller communicatively coupled to the memory, the wireless communication interface, and the transceiver, and which: receives a configuration message originating from a network device, the configuration message comprising information for configuring an access link reference signal; and in response to receiving the configuration message, configures the device to measure an access link between the device and the reconfigurable intelligent surface and provide a CSI report of the access link. The controller further transmits, to the network device, the CSI report of the access link.

In one or more embodiments, the controller receives, from the network device, a request to establish a device-to-device connection with the reconfigurable intelligent surface, the request comprising reference signals to be exchanged during device-to-device communication. The controller establishes the device-to-device connection via the wireless communication interface, and the controller forwards, to the reconfigurable intelligent surface, a CSI RS for transmitting to the network device via a Uu link over the C-link.

In one or more embodiments, the controller receives the configuration message from the network device via the reconfigurable intelligent surface. The controller receives, from the network device via the reconfigurable intelligent surface (RIS), UE resources of device-to-device reference signals transmitted by the RIS on active elements of the RIS. The controller configures a device-to-device link based on the received resources.

In one or more embodiments, the controller receives, from the network device, a resource configuration to report, on a Uu link, a measured access channel between the reconfigurable intelligent surface and the device. The controller, in response to receiving the resource configuration: measures one or more characteristics of the access channel; and generates a measured access channel report and transmits the measured access channel report on the Uu link to the network device, via the reconfigurable intelligent surface.

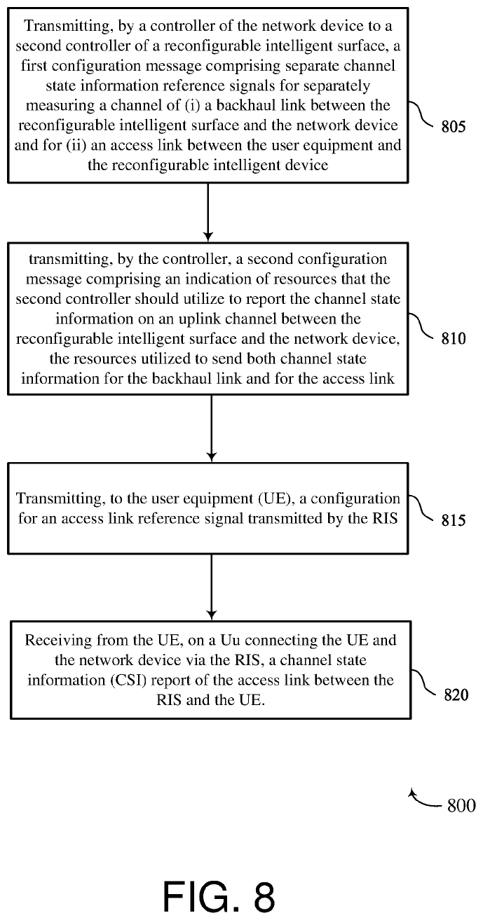

FIG. 8 illustrates a flowchart of a method, performed by a network device, for configuring a reconfigurable intelligent surface with optimal parameters to reflect downlink and uplink signals to and from a communication device, in accordance with aspects of the present disclosure. The operations of the method 800 may be implemented by a network device or its components as described herein. For example, the operations of the method 800 may be performed by a network device 102, 502 as described with reference to FIGS. 1 and 3-5. In some implementations, the network device may execute a set of instructions to control the function elements of the network device to perform the described functions. Additionally, or alternatively, the network device may perform aspects of the described functions using special-purpose hardware.

At 805, the method 800 may include transmitting, by a controller of the network device to a second controller of a reconfigurable intelligent surface, a first configuration message comprising separate channel state information reference signals for separately measuring a channel of (i) a backhaul link between the reconfigurable intelligent surface and the network device and for (ii) an access link between the user equipment and the reconfigurable intelligent device. The operations of 805 may be performed in accordance with examples as described herein. In some implementations, aspects of the operations of 805 may be performed by a device as described with reference to FIGS. 1 and 3-5.

At 810, the method 800 may include transmitting, by the controller, a second configuration message comprising an indication of resources that the second controller should utilize to report the channel state information on an uplink channel between the reconfigurable intelligent surface and the network device, the resources utilized to send both channel state information for the backhaul link and for the access link. The operations of 810 may be performed in accordance with examples as described herein. In some implementations, aspects of the operations of 810 may be performed by a device as described with reference to FIGS. 1 and 3-5.

At 815, the method 800 may include transmitting, to the user equipment (UE), a configuration for an access link reference signal transmitted by the RIS. The operations of 815 may be performed in accordance with examples as described herein. In some implementations, aspects of the operations of 815 may be performed by a device as described with reference to FIGS. 1 and 3-5.

At 820, the method 800 may include receiving from the UE, on a Uu connecting the UE and the network device via the RIS, a channel state information (CSI) report of the access link between the RIS and the UE. The operations of 820 may be performed in accordance with examples as described herein. In some implementations, aspects of the operations of 820 may be performed by a network device, such as gNB 102, as described with reference to FIGS. 1 and 3-5.

In one or more embodiments, the method 800 may include transmitting, to the user equipment (UE), a configuration for an access link reference signal transmitted by the RIS. The method 800 may include receiving from the UE, on a Uu connecting the UE and the network device via the RIS, a channel state information (CSI) report of the access link between the RIS and the UE.

In one or more embodiments, the method 800 may include receiving, from the RIS, the CSI for at least one of the backhaul link and the C-link, where the CSI is received on UCI via one of PUCCH or PUSCH in one of: (i) a dedicated CSI report of a forward link comprising the backhaul link and the access link; or (ii) a combined CSI report comprising the dedicated CSI report and a CSI of the C-link. The method 800 may include performing one or more signal processing schemes to retrieve one or more complete channel(s) on all RIS elements.

In one or more embodiments, the method 800 may include determining, from a received RIS capability report, that the RIS supports a set of active elements that are connected to a radio frequency (RF) chain and a base band processor. The method 800 may include initiating a transmission of the first configuration message and the second configuration message in response to determining that the RIS supports the set of active elements.

In one or more embodiments, the method 800 may include identifying that a backhaul beam and a C-link beam connecting the network device to the RIS are different. The method 800 may include in response to the backhaul beam and the C-link beam being different, incorporating, within the first configuration message, a first set of CSI reference signal (RS) resources for measuring a C-link beam, and a second set of CSI-RS resources for the CSI-RS configured for the UE.

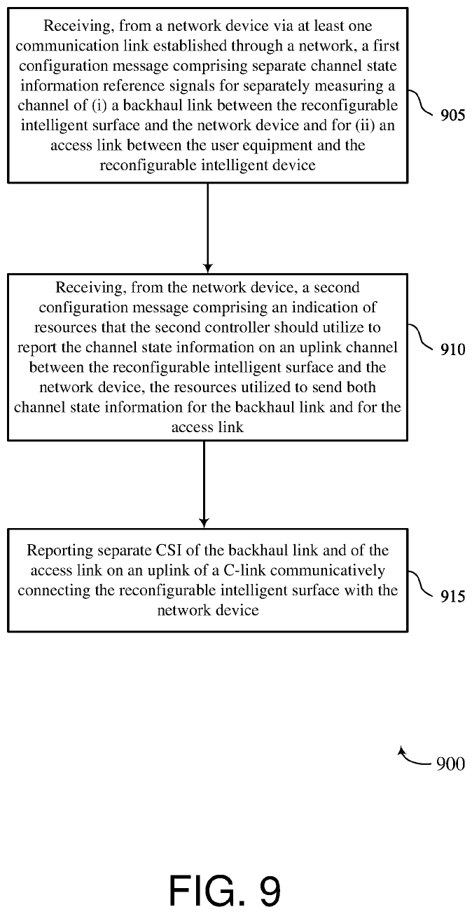

FIG. 9 illustrates a flowchart of a method, performed by an intermediate network device, for receiving configuration messages that enables transmission of separate CSI reports for an access channel and a C-link, in accordance with aspects of the present disclosure. The operations of the method 900 may be implemented by a device or its components as described herein. For example, the operations of the method 900 may be performed by an RIS 150 or device 602 as described with reference to FIGS. 1, 3-4 and 6. In some implementations, the RIS 150 or RIS controller 305 may execute a set of instructions to control the function elements of the RIS to perform the described functions.

At 905, the method may include receiving, from a network device via at least one communication link established through a network, a first configuration message comprising separate channel state information reference signals for separately measuring a channel of (i) a backhaul link between the reconfigurable intelligent surface and the network device and for (ii) an access link between the user equipment and the reconfigurable intelligent device. The operations of 905 may be performed in accordance with examples as described herein. In some implementations, aspects of the operations of 905 may be performed by a device as described with reference to FIGS. 1, 3-4 and 6.

At 910, the method may include receiving, from the network device, a second configuration message comprising an indication of resources that the second controller should utilize to report the channel state information on an uplink channel between the reconfigurable intelligent surface and the network device, the resources utilized to send both channel state information for the backhaul link and for the access link. The operations of 910 may be performed in accordance with examples as described herein. In some implementations, aspects of the operations of 910 may be performed by a device as described with reference to FIGS. 1, 3-4 and 6.

At 915, the method may include reporting separate CSI of the backhaul link and of the access link on an uplink of a C-link communicatively connecting the reconfigurable intelligent surface with the network device. The operations of 915 may be performed in accordance with examples as described herein. In some implementations, aspects of the operations of 915 may be performed by a device as described with reference to FIGS. 1, 3-4 and 6.

In one or more embodiments, the method 900 may include identifying whether a current configuration of the device provides a same beam being utilized for both the C-link and the backhaul link. The method 900 may include transmitting a single CSI report in response to the configuration of the device providing for the same beam being utilized for both the C-link and the backhaul link. The method 900 may include, in response to a different beam being utilized for the C-link and for the backhaul link, reporting a respective CSI of both the C-link and a forward link comprising the backhaul link and the access link.

In one or more embodiments, the method 900 may include transmitting to the user equipment (UE), a configuration for measuring the access link and reporting an access link reference signal. The method 900 may include receiving, from the UE, a channel state information (CSI) report of the access link between the device and the UE. The method 900 may include forwarding the received CSI report to the network device as an access link CSI report.

In one or more embodiments, the method 900 may include receiving, from the network device, a request for a RIS capability report, the RIS capability report comprising information of a number of supported elements for measurement, a distribution of the supported elements on the RIS, and whether the supported elements are connected to the radio frequency (RF) chain(s) of the RIS. The method 900 may include forwarding, to the network device, the RIS capability report, which indicates that the RIS supports a set of active elements that are connected to the radio frequency chain and a base band processor, the RIS capability report triggering a transmission of the first configuration message and the second configuration message by the network device, in response to determining that the RIS supports the set of active elements.

In one or more embodiments, the method 900 may include receiving a configuration message comprising one or more configurations for the device and the UE to establish a device-to-device connection. The method 900 may include configuring the device with resources for sidelink reference signals (SRS) comprising information related to reference signals to be exchanged between the RIS and the UE in a device-to-device communication. The method 900 may include establishing the device-to-device connection with the UE and transmitting, to the UE, resources of device-to-device reference signals transmitted by the RIS on active elements of the RIS. The method 900 may include providing the resources for SRS for use within a sidelink channel with the UE.

In one or more embodiments, the method 900 may include receiving the CSI-RS of the access link from the UE and determining the CSI of the backhaul link. The method 900 may include generating a forward link CSI report comprising the CSI of both the backhaul link and the access link. The method 900 may include determining the CSI of the C-link. The method 900 may include generating a combined CSI report comprising both the forward link CSI report and the CSI of the C-link. The method 900 may include forwarding the combined CSI report to the network device on an UCI over the C-link via one of PUCCH or PUSCH.

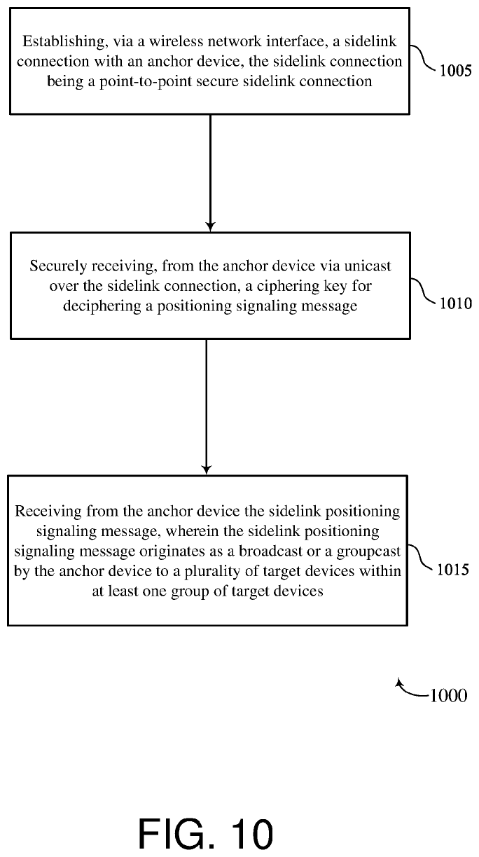

FIG. 10 illustrates a flowchart of a method, performed by a communication device, for supporting wireless communication and providing CSI reports of an access channel between the RIS and the device, separate from CSI reports of a downlink channel to the RIS to enable optimal configuration of the RIS, in accordance with aspects of the present disclosure. The operations of the method 1000 may be implemented by a device or its components as described herein. For example, the operations of the method 1000 may be performed by a UE 104 or communication device 702 as described with reference to FIGS. 1, 3-4 and 7. In some implementations, the UE 104 may execute a set of instructions to control the function elements of the UE 104 to perform the described functions. Additionally, or alternatively, the UE 104 may perform aspects of the described functions using special-purpose hardware.

At 1005, the method may include receiving, by a controller of the communication device, a configuration message originating from a network device, the configuration message comprising information for configuring an access link reference signal. The operations of 1005 may be performed in accordance with examples as described herein. In some implementations, aspects of the operations of 1005 may be performed by a device as described with reference to FIGS. 1, 3-4 and 7.

At 1010, the method may include, in response to receiving the configuration message, configuring the device to measure an access link between the device and the reconfigurable intelligent surface and provide a CSI report of the access link. The operations of 1010 may be performed in accordance with examples as described herein. In some implementations, aspects of the operations of 1010 may be performed by a device as described with reference to FIGS. 1, 3-4 and 7.

At 1015, the method may include transmitting, to the network device, the CSI report of the access link. The operations of 1015 may be performed in accordance with examples as described herein. In some implementations, aspects of the operations of 1015 may be performed by a device as described with reference to FIGS. 1, 3-4 and 7.

In one or more embodiments, the method 1000 may include receiving, from the reconfigurable intelligent surface, a request to establish a device-to-device connection, the request comprising reference signals to be exchanged during device-to-device communication. The method 1000 may include establishing the device-to-device connection via the wireless communication interface. The method 1000 may include forwarding, to the reconfigurable intelligent surface, a CSI RS for transmitting to the network device via a Uu link over the C-link.

In one or more embodiments, the method 1000 may include receiving the configuration message from the network device via the reconfigurable intelligent surface. The method 1000 may include receiving, from the network device via the RIS, UE resources of device-to-device reference signals transmitted by the RIS on active elements of the RIS. The method 1000 may include configuring a device-to-device link based on the received resources.

In one or more embodiments, the method 1000 may include receiving, from the network device, a resource configuration to report, on a Uu link, a measured access channel between the reconfigurable intelligent surface and the device. The method 1000 may include, in response to receiving the resource configuration: measuring one or more characteristics of the access channel; generating a measured access channel report; and transmitting the measured access channel report on the Uu link to the network device, via the reconfigurable intelligent surface.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A base station for wireless communication, the base station comprising:
at least one memory; and
at least one processor communicatively coupled to the at least one memory, and which is configured to cause the base station to:
transmit, to a reconfigurable intelligent surface (RIS), a first configuration message comprising separate channel state information (CSI) reference signals for separately measuring a channel of (i) a backhaul link between the RIS and the base station and (ii) an access link between a user equipment (UE) and the RIS; and
transmit, to the RIS, a second configuration message comprising an indication of resources that the RIS should utilize to report the channel state information on an uplink channel between the RIS and the base station, the resources utilized to send both channel state information for the backhaul link and for the access link.

2. The base station of claim 1, wherein the at least one processor is further configured to cause the base station to:
transmit, to the UE, a configuration for an access link reference signal transmitted by the RIS; and
receives from the UE, on a Uu connecting the UE and the base station, a channel state information (CSI) report of the access link between the RIS and the UE.

3. The base station of claim 1, wherein the at least one processor is further configured to cause the base station to:
receive, from the RIS, the CSI for at least one of the backhaul link and a control link (C-link), wherein the CSI is received on UCI via one of PUCCH or PUSCH in one of: (i) a dedicated CSI report of a forward link comprising the backhaul link and the access link; or (ii) a combined CSI report comprising the dedicated CSI report and a CSI of the C-link; and
perform one or more signal processing schemes to retrieve one or more complete channel(s) on all RIS elements.

4. The base station of claim 3, wherein the at least one processor is further configured to cause the base station to:
receive the CSI as individual CSI reports for each active element of the RIS, in response to one of (a) each active element being connected to different RF chains or (b) a RS within each of the individual CSI reports corresponding to a power measured for an associated active element.

5. The base station of claim 1, wherein the at least one processor is further configured to cause the base station to:
transmit, to the RIS, a request for a RIS capability report comprising information of a number of supported elements for measurement, a distribution of the supported elements on the RIS in order for the base station to retrieve a complete channel on passive elements, and whether the supported elements are connected to RF chain(s) of the RIS;
determine, from a received RIS capability report, that the RIS supports a set of active elements that are connected to a radio frequency (RF) chain and a base band processor; and
initiate a transmission of the first configuration message and the second configuration message in response to determining that the RIS supports the set of active elements.

6. The base station of claim 1, wherein the at least one processor is further configured to cause the base station to:
identify that a backhaul beam and a C-link beam connecting the base station to the RIS are different; and
in response to the backhaul beam and the C-link beam being different, incorporate within the first configuration message a first set of CSI reference signal (RS) resources for measuring a C-link beam, and a second set of CSI-RS resources for the CSI-RS configured for the UE.

7. The base station of claim 1, wherein:
the first configuration message configures the RIS with resources for receiving and measuring the reference signals from the UE during a transmission of the UE in one or more uplink slots to enable the base station to estimate the access link channel; and
the at least one processor is further configured to cause the base station to combine a first CSI of a Uu link from the UE, via the RIS, to the base station, and a second CSI of the access link from the UE to the RIS to generate a complete access link channel.

8. The base station of claim 1, wherein:
the first configuration message configures the RIS with uplink resources to signal, via a control link (C-link) to the base station, a channel of a measured sounding reference signal (SRS) transmitted by the UE in the uplink (UL) to the base station; and
the at least one processor is further configured to cause the base station to:
receive the channel of the measured SRS of the access link on an active element of the RIS; and
in response to receiving the channel of the measured SRS, retrieve the channel for a remainder of passive elements to optimize the RIS for a cascaded channel of a forward link.

9. A method for wireless communication at a base station, the method comprising:
transmitting, to a reconfigurable intelligent surface (RIS), a first configuration message comprising separate channel state information reference signals for separately measuring a channel of (i) a backhaul link between the RIS and the base station and for (ii) an access link between a user equipment (UE) and the RIS; and
transmitting a second configuration message comprising an indication of resources that the RIS should utilize to report the channel state information on an uplink channel between the RIS and the base station, the resources utilized to send both channel state information for the backhaul link and for the access link.

10. A device for wireless communication, the device comprising:
a physical surface comprising active elements and passive elements of a reconfigurable intelligent surface (RIS);
a controller module communicatively coupled to at least each of the active elements within the RIS to provide an RIS terminal, the controller module comprising:
a wireless communication interface that enables the device to communicate with a user equipment (UE) via a device-to-device communication link; and
at least one memory; and
a communicatively coupled to the at least one memory and the wireless communication interface, and which is configured to cause the device to:
receive, from a base station via at least one communication link established through a network, a first configuration message comprising separate channel state information (CSI) reference signals (RS) for separately measuring a channel of (i) a backhaul link between the RIS and the base station and for (ii) an access link between the user equipment and the RIS;
receive, from the base station, a second configuration message comprising an indication of resources that the second controller should utilize to report the CSI on an uplink channel between the RIS and the base station, the resources utilized to send both CSI for the backhaul link and for the access link; and
report separate CSI of the backhaul link and of the access link on an uplink of a control link (C-link) communicatively connecting the device with the base station.

11. The device of claim 10, wherein the controller is further configured to cause the device to:
identify whether a current configuration of the device provides a same beam being utilized for both the C-link and the backhaul link;
transmit a single CSI report in response to the configuration of the device providing for the same beam being utilized for both the C-link and the backhaul link; and
in response to a different beam being utilized for the C-link and for the backhaul link, report a respective CSI of both the C-link and a forward link comprising the backhaul link and the access link.

12. The device of claim 10, wherein the controller is configured to cause the device to:
transmit to the UE, a configuration for measuring the access link and reporting an access link reference signal;
receive, from the UE, a CSI report of the access link between the device and the UE; and
forward the received CSI report to the base station as an access link CSI report.

13. The device of claim 10, wherein the controller is configured to cause the device to:
forward, to the base station, the CSI as individual CSI reports for each active element of the RIS, in response to one of (a) each active element being connected to different RF chains or (b) a RS within each of the individual CSI reports being a power measured per an associated active element.

14. The device of claim 10, wherein the controller is configured to cause the device to:
receive, from the base station, a request for a RIS capability report comprising information of a number of supported elements for measurement, a distribution of the supported elements on the RIS, and whether the supported elements are connected to a radio frequency (RF) chain(s) of the RIS; and
forward, to the base station, a RIS capability report, which indicates that the RIS supports a set of active elements that are connected to the RF chain and a base band processor, the RIS capability report triggering a transmission of the first configuration message and the second configuration message by the base station, in response to the base station determining that the RIS supports the set of active elements.

15. The device of claim 10, wherein the controller is configured to cause the device to:
receive, from the base station, a configuration message comprising one or more configurations for the device and the UE to establish a device-to-device connection;
configure the device with resources for sidelink reference signals comprising information related to reference signals to be exchanged between the RIS and the UE in a device-to-device communication;
establish the device-to-device connection with the UE;
transmit, to the UE, resources of device-to-device reference signals transmitted by the RIS on active elements of the RIS; and
provide the resources for reference signal for use within a sidelink channel with the UE.

16. The device of claim 10, wherein the controller is configured to cause the device to:
receive the CSI-RS of the access link from the UE;
determine the CSI of the backhaul link;
generate a forward link CSI report comprising the CSI of both the backhaul link and the access link;
determine the CSI of the C-link;
generate a combined CSI report comprising both the forward link CSI report and the CSI of the C-link; and
forward the combined CSI report to the base station on an UCI over the C-link via one of a physical uplink control channel (PUCCH) or a physical uplink shared channel (PUSCH).

17. A user equipment (UE) for wireless communication, the UE comprising:
a wireless communication interface that enables the UE to communicate via a device-to-device communication link with a reconfigurable intelligent surface (RIS);
at least one memory; and
at least one processor communicatively coupled to the at least one memory and the wireless communication interface and which is configured to cause the UE to:
receive a configuration message originating from a base station, the configuration message comprising information for configuring an access link reference signal;
in response to receiving the configuration message, configure the UE to measure an access link between the UE and the RIS and provide a channel state information (CSI) report of the access link; and
transmit, to the base station, the CSI report of the access link.

18. The UE of claim 17, wherein the at least one processor is configured to cause the UE to:
receive, from the base station, a request to establish a device-to-device connection with the RIS, the request comprising reference signals to be exchanged during device-to-device communication;
establish the device-to-device connection via the wireless communication interface; and
forward, to the RIS, a CSI reference signal (RS) for transmitting to the base station via a Uu link over a control link (C-link).

19. The UE of claim 17, wherein the at least one processor is configured to cause the UE to:
receive the configuration message from the base station via the RIS;
receive, from the base station via the RIS, UE resources of device-to-device reference signals transmitted by the RIS on active elements of the RIS; and
configure a device-to-device link based on the received resources.

20. The UE of claim 17, wherein the at least one processor is further configured to cause the UE to:
receive, from the base station, a resource configuration to report, on a Uu link, a measured access channel between the RIS and the device; and
in response to receiving the resource configuration:
measure one or more characteristics of the access channel; and
generate a measured access channel report and transmits the measured access channel report on the Uu link to the base station, via the RIS.
